(19) United States
(12) Patent Application Publication
(10) Pub. No.: US 2007/0257394 A1
(43) Pub. Date: Nov. 8, 2007

(54) Feeder for Agglomerating Particles

(75) Inventors: James Borkenhagen, Spring Valley, CA (US); Porter Mitchell, San Diego, CA (US)

Correspondence Address: Maxwell Technologies, Inc.;IP Department, 9244 Balboa Avenue, San Diego, CA, 92123, US

(73) Assignee: Maxwell Technologies, Inc., San Diego, CA (US)

(21) Appl. No.: 11/382,212

(22) Filed: May 8, 2006

(51) Int. Cl. B29C 67/00

(52) U.S. Cl. 264/117; 425/333; 425/222

(57) ABSTRACT

In one embodiment, a feeder for agglomerating particles comprises an enclosure that has an inlet and an outlet and that is adapted to receive a predetermined amount of the agglomerating particles. An inlet valve controls entry into the enclosure, while an outlet valve controls discharge from the enclosure. A transportation system such as an auger system carries the agglomerating particles from the outlet valve to the inner portion of a drum, and, in order to prevent a clogging of the transportation system, the speed of the transportation system is coordinated with the opening rate of the outlet valve. The drum is adapted to spread out the agglomerating particles through perforations in the drum wall, so to cause the agglomerating particles to be delivered from the inner portion of the drum to a conveyor system outside the drum at a substantially uniform rate.

### STATEMENT REGARDING FEDERALLY SPONSORED RESEARCH AND DEVELOPMENT

Not applicable.

### REFERENCE TO A COMPUTER LISTING, A TABLE, OR A COMPUTER PROGRAM LISTING COMPACT DISK APPENDIX

Not applicable.

### BACKGROUND OF THE INVENTION

1. Field of the Invention

The present invention relates to a feeder system for agglomerating particles, and, more particularly, to a feeder system wherein the agglomerating particles are fed to their final use in a continuous and uniform manner.

2. Description of Related Art

Agglomerating particles are typically powdery systems that tend to aggregate in clumps during handling. This tendency to agglomerate causes severe problems in a manufacturing environment. For instance, if the agglomerating particles must be calendered into a film produced by squeezing the particles between nip rolls, the clumps cause the rolls to distribute the particles in a non-uniform manner over the width and length of the film.

In order to insure an even distribution, aggregating particles must be delivered to calendering stations in batches, with operators manually spreading the particles across the conveyor belts feeding the nip rolls. Such a process is inefficient, due to the economic disadvantages of operating in a batch production system and to the inherent quality variations from batch to batch.

Therefore, there is a need for a feeder system for agglomerating particles that will prevent the clumping of agglomerating particles during handling.

There is a further need for a feeder system for agglomerating particles that will provide greater manufacturing efficiencies than batch feeder systems.

### BRIEF SUMMARY OF THE INVENTION

In one embodiment, a feeder for agglomerating particles comprises an enclosure that has an inlet and an outlet and that is adapted to receive a predetermined amount of the agglomerating particles. An inlet valve controls entry into the enclosure, while an outlet valve controls discharge from the enclosure. A transportation system such as an auger system carries the agglomerating particles from the outlet valve to the inner portion of a drum, and, in order to prevent a clogging of the transportation system, the speed of the transportation system is coordinated with the opening rate of the outlet valve. The drum is adapted to spread out the agglomerating particles through perforations in the drum wall, so to cause the agglomerating particles to be delivered from the inner portion of the drum to a conveyor system outside the drum at a substantially uniform rate.

It is an advantage of the present invention to provide a feeder system that prevents the clumping of agglomerating particles, thereby enabling a uniform delivery of the agglomerating particles to their final use.

It is another advantage of the present invention to provide a continuous feeder system for agglomerating particles that enables greater manufacturing efficiencies than in batch feeder systems.

### BRIEF DESCRIPTION OF THE SEVERAL VIEWS OF THE DRAWINGS

The drawings constitute a part of this specification and include an exemplary embodiment of the invention, which may be embodied in various forms. It is to be understood that in some instances various aspects of the invention may be shown exaggerated or enlarged to facilitate an understanding of the invention.

FIG. 1 illustrates a first perspective view of a feeder system according to the exemplary embodiment of the invention.

FIG. 2 illustrates a second different perspective view of the embodiment of FIG. 1.

FIG. 3 illustrates a perspective view of the transportation system, of the perforated drum and of the collector system that are included in the embodiment of FIG. 1.

### DETAILED DESCRIPTION OF THE INVENTION

A detailed description of an exemplary embodiment of the invention is provided herein. It is to be understood, however, that the present invention may be embodied in various forms. Therefore, the specific details disclosed herein are not to be interpreted as limiting, but rather as a representative basis for teaching one skilled in the art how to employ the present invention in virtually any detailed system, structure, or manner.

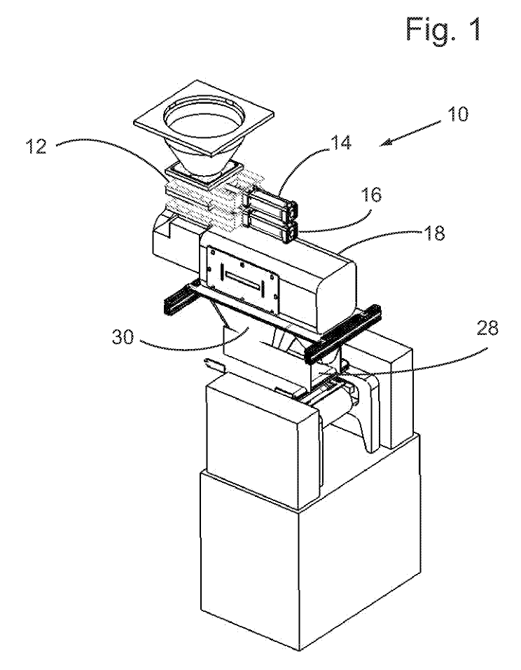

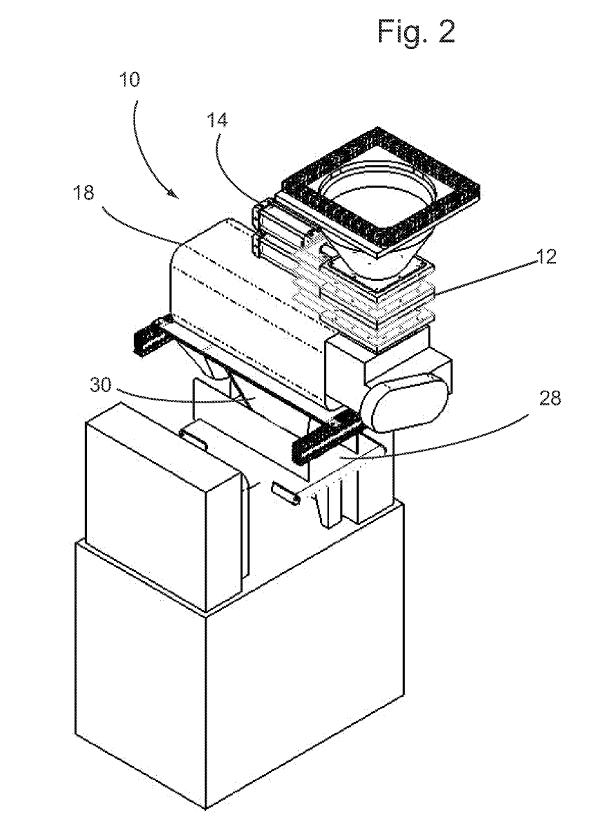

Turning first to FIGS. 1 and 2, there are shown two perspective views of the exemplary embodiment 10 of the invention. Agglomerating particles, in a form of a clumpy powdery product, are deposited from a hopper into an enclosure 12 having an inlet for receiving the powdery product and an outlet for discharging the powdery product. Entry through the inlet is regulated by an inlet valve 14, which, in an open position, causes the powdery product to enter enclosure 12 and which, in a closed position, prevents the powdery product from entering enclosure 12. Conversely, discharge through the outlet is regulated by an outlet valve 16, which prevents the powdery product from leaving enclosure 12 in a closed position, and which allows the powdery product to leave enclosure 12 in a closed position. The openings and closings of inlet valve 14 and of outlet valve 16 are timed to enable only a predetermined amount (measured in volume or in weight) of the powdery product to enter enclosure 12. More particularly, outlet valve 16 may be programmed to open at a speed that will provide for a discharge of the powdery product from enclosure 12 at a predetermined rate.

The powdery product discharged from enclosure 12 is successively fed to a perforated drum, typically a cylindrical drum (shown in FIGS. 1-2 as contained within encasement 18), into which the powdery product typically enters through the base of the cylinder, and which has perforations situated on the wall of the cylinder.

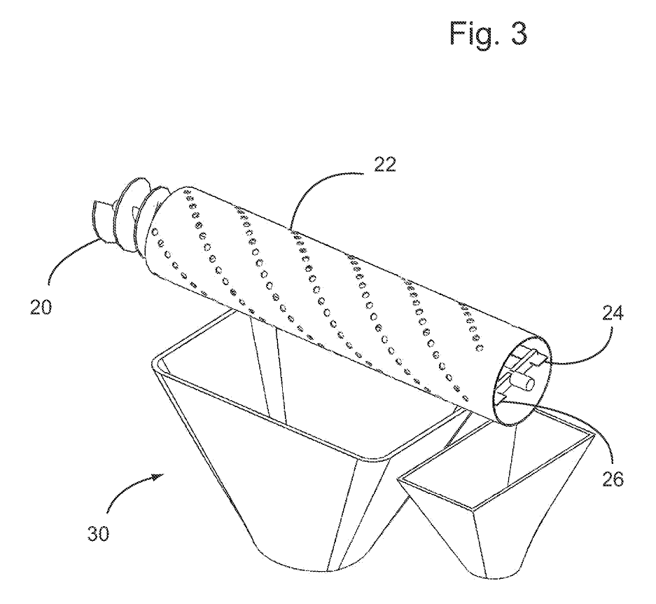

Turning now to FIG. 3, there is shown an illustration of the transportation of the powdery product from the outlet of the enclosure outlet to the perforated drum. The powdery product discharged from enclosure 12 is first fed into an auger 20 that delivers the powdery product to perforated drum 22. One skilled in the art will recognize that auger 20 is set to turn at such a speed to provide for a constant feed of powdery product to perforated drum 22 while avoiding the clumping of the powdery product within auger 20, which would cause an irregular operation of auger 20.

Inside perforated drum 22 there are one or more blades that rotate around the axis of perforated drum 22, pushing the powdery product against the inner wall of perforated drum 22 and causing the powdery product to be ejected from perforated drum 22 through the wall perforations. The operation of perforated drum 22 with two blades 24 and 26 is illustrated in FIG. 4. Blades 24 and 26 will preferably have a spiral orientation, that is, their longitudinal extension will not be in a straight line but exhibit a spiral pattern instead, preferably with a five degree spiral angle.

The operation of perforated drum 22 causes the powdery product to be discharged from perforated drum 22 in a manner similar to snow flakes, and to be deposited uniformly on a conveyor belt 28 situated below perforated drum 20. In turn, conveyor belt 28 delivers the powdery product to its final destination, for instance, to nip rolls if the powdery product is to be calendered.

The flow of the powdery product to conveyor belt 28 may be facilitated by a collector system 30 directing the powdery product from perforated drum 22 onto conveyor belt 28. As illustrated in FIG. 5, collector system 30 may comprise two inclined walls 32 and 34 arranged in a narrowing pattern, so to reduce the area within which the powdery product move. This will minimize dispersions and losses of the powdery product, and also increase coverage uniformity over the conveyor belt.

Another embodiment of the present invention relates to a method for feeding agglomerating particles. The embodiment incorporates the above described steps.

While the invention has been described in connection with the above described embodiments, it is not intended to limit the scope of the invention to the particular forms set forth, but on the contrary, it is intended to cover such alternatives, modifications, and equivalents as may be included within the scope of the invention.

What is claimed is:

1. A feeder for agglomerating particles, the feeder comprising:
an enclosure having an inlet and an outlet, the enclosure being adapted to receive a predetermined amount of the agglomerating particles, entry through the inlet being controlled by an inlet valve and discharge through the outlet being controlled by an outlet valve; and
a transportation system carrying the agglomerating particles from the outlet to the inside of a drum, wherein the speed of the transportation system is coordinated with the opening rate of the outlet valve to prevent a clogging of the transportation system,
the drum being adapted to distribute the agglomerating particles through perforation in the drum from the inside of the drum to a conveyor system outside of the drum at a substantially uniform rate.

2. The feeder for agglomerating particles of claim 1, wherein the predetermined amount of the agglomerating particles is controlled by opening the inlet valve to receive the agglomerating particles from an external source while maintaining the outlet valve in a closed position, and by closing the inlet valve when the predetermined amount is achieved.

3. The feeder for agglomerating particles of claim 1, wherein the transportation system is an auger system.

4. The feeder for agglomerating particles of claim 1, wherein the agglomerating particles are distributed through the perforations by providing one or more blades that rotate angularly in relation to the direction of travel of the agglomerating particles inside the drum, the one or more blades promoting the distribution of the particles from the inside the drum to the perforations.

5. The feeder for agglomerating particles of claim 4, wherein the one or more blades have a spiral orientation in relation to the direction of travel of the agglomerating particles.

6. The feeder for agglomerating particles of claim 5, wherein the spiral orientation has a spiral angle of approximately five degrees.

7. The feeder for agglomerating particles of claim 1, wherein the perforated drum has a cylindrical wall.

8. The feeder for agglomerating particles of claim 1, wherein the conveyor system is a conveyor belt.

9. The feeder for agglomerating particles of claim 1, further comprising a collector system for directing the agglomerating particles from the perforations to the conveyor system.

10. The feeder for agglomerating particles of claim 1, wherein the collector system comprises a plurality of walls inclined in a narrowing pattern so to receive the agglomerating particles from the perforated drum over a larger surface and to direct the agglomerating particles to the transportation system over a smaller surface.

11. A method for feeding agglomerating particles, the method comprising:
(a) feeding the agglomerating particles to an enclosure having an inlet and an outlet, the enclosure being adapted to receive a predetermined amount of the agglomerating particles, entry through the inlet being controlled by an inlet valve and discharge through the outlet being controlled by an outlet valve;
(b) transporting the agglomerating particles from the outlet to the inside of a drum, wherein the speed of the transportation system is coordinated with the opening rate of the outlet valve to preventing a clogging of the transportation system, and
(c) delivering the agglomerating particles through perforations in the drum from the inside of the drum to a conveyor system outside of the drum at a substantially uniform rate.

12. The method of claim 11, wherein the predetermined amount of the agglomerating particles is controlled by opening the inlet valve to receive the agglomerating particles from an external source while maintaining the outlet valve in a closed position, and by closing the inlet valve when the predetermined amount is achieved.

13. The method of claim 11, wherein the agglomerating particles are transported from the outlet to the inside of a drum by the use of an auger system.

14. The method of claim 11, wherein the agglomerating particles are distributed through the perforations by providing one or more blades that rotate angularly in relation to the direction of travel of the agglomerating particles inside the drum, the one or more blades promoting the distribution of the particles from the inside the drum to the perforations.

15. The method of claim 11, wherein the one or more blades are provided with a spiral orientation in relation to the direction of travel of the agglomerating particles.

16. The method of claim 15, wherein the spiral orientation is provided with a spiral angle of approximately five degrees.

17. The method of claim 11, wherein the perforated drum is provided with a cylindrical wall.

18. The method of claim 11, the conveyor system is a conveyor belt.

19. The method of claim 11, further comprising the step of providing a collector system for directing the agglomerating particles from the perforations to the conveyor system.

20. The method of claim 11, wherein the collector system is provided with a plurality of walls inclined in a narrowing pattern so to receive the agglomerating particles from the perforated drum over a larger surface and to direct the agglomerating particles to the transportation system over a smaller surface.
